(19) United States
(12) Patent Application Publication
(10) Pub. No.: US 2025/0209518 A1
(43) Pub. Date: Jun. 26, 2025

(54) System and Method for Multi-Store Price Optimization and Seamless Checkout

(71) Applicant: iCompare, LLC, Covington, LA (US)

(72) Inventors: Damian Day, Hammond, LA (US); Devin Denoux, Covington, LA (US)

(73) Assignee: iCompare, LLC, Covington, LA (US)

(21) Appl. No.: 18/887,028

(22) Filed: Sep. 16, 2024

Related U.S. Application Data
(60) Provisional application No. 63/582,713, filed on Sep. 14, 2023.

(51) Int. Cl. G06Q 30/0601; G06Q 30/0283

(52) U.S. Cl. CPC G06Q 30/0633; G06Q 30/0283; G06Q 30/0629

(57) ABSTRACT

A system and method for optimizing shopping across multiple stores includes collecting and normalizing price data, matching similar products, calculating the lowest prices, creating optimized shopping lists for respective users, and integrating a unified cart and a single payment gateway for seamless checkout. The system and method enhances the shopping experience of users by providing and optimizing price comparisons for desired products, thereby maximizing savings and minimizing store visits for the users.

### CROSS-REFERENCE TO RELATED APPLICATIONS

This application claims the benefit of priority of pending U.S. Provisional Application No. 63/582,713, filed Sep. 14, 2023, the disclosure of which is hereby incorporated by reference in its entirety.

### BACKGROUND OF THE INVENTION

### Field of the Invention

The present invention relates generally to a system and method for enhancing shopping experience of users, and more particularly, to a system and method for multi-store price optimization and seamless checkout.

### Description of the Related Art

Users regularly shop for grocery items regularly. Some items (e.g., food or dairy products) may be bought by the users on a daily basis, while other grocery products are bought on a weekly basis or less frequently. It is known that users face difficulties in finding the best prices for items when shopping across multiple stores. As an example, one or more items of a user's shopping list may be sold at a particular store at a minimum or discounted price, while other items in the shopping list may be sold at a minimum price at another store. Often times, the users are not aware that a specific store is offering a discounted price for a particular item, till the user visits the store. It is not possible or highly inconvenient for the user to visit multiple stores to purchase items in the shopping list at the lowest possible price. Lack of knowledge of minimum offered prices for items across multiple stores results in a suboptimal shopping experience for the user.

Existing solutions do not efficiently optimize both cost savings and user convenience, often requiring visits to different stores by the user. Even if the user avails the option of online shopping for grocery items, the user is required to perform multiple transactions across different applications to purchase items in the shopping list, which may cause considerably inconvenience to the user.

A need exists for a system and method for optimizing multi-store shopping experience for users, without requiring the users to manually visit each store to determine the lowest possible item rates/prices.

None of the conventional solutions disclose the unique advantages and characteristics of the present disclosure. The invention disclosed herein overcomes many of the drawbacks of conventional systems and methods.

Accordingly, there is a need for an improved system and method optimizes price comparison across multiple stores and provide a seamless checkout experience to the users.

It is one prospect of the present invention to provide a system and method that automatically identifies the stores that are offering lowest prices for the items in the user's shopping list, and display the store information to the user.

Another object of the present invention is to provide a novel system and method that enables the user to purchase the items in the user's shopping list from across multiple stores via a single checkout process/transaction.

Yet another object of the disclosed invention is to provide a system and method that is easy to use and provides an enhanced multi-store shopping experience to the user, without requiring the user to manually visit each store to the check the item prices.

As disclosed in this application, the inventor has discovered a novel and unique system and method that offers multi-store price optimization and seamless checkout experience. The system and method may be conveniently used by users for purchasing daily-use grocery (or other) items, without having to spend considerable time and effort in determining the stores that are offering the lowest prices for the items in the user's shopping list.

### SUMMARY OF THE INVENTION

The following presents a simplified summary of the present disclosure in a simplified form as a prelude to the more detailed description that is presented herein.

Therefore, in accordance with embodiments of the invention, there is provided a system for optimizing multi-store shopping as detailed herein.

In a preferred embodiment, the system includes a processor and a memory. The memory stores instructions that may be executed by the processor to perform steps described below. In some aspects, the processor may obtain, via a shopping list collection module, a shopping list from a user. The shopping list may include one or more items. The processor may collect, via a data collection module, an item information associated with the one or more items from a plurality of stores. The item information may include a price information for the one or more items offered by the plurality of stores. In addition, the processor may normalize, via a data normalization module, the item information to standardized units, formats, and names across the plurality of stores to form a normalized item information. Based on the normalized item information, the processor may compare, via a product matching module, prices of matching items across the plurality of stores. Based on the comparison, the processor may determine, via a price optimization module, a lowest price of each item from the one or more items across the plurality of stores. Responsive to determining the lowest price of each item across the plurality of stores, the processor may identify, via the price optimization module, one or more stores from the plurality of stores to purchase the one or more items. The processor may display, via a display module, an information associated with the one or more stores.

In one embodiment, the processor may obtain, via a user preferences module, user preferences from the user. The user preferences may include at least one of store preferences, dietary restrictions, or a budget information. The processor may obtain the user preferences responsive to obtaining the shopping list from the user. In another embodiment, the processor may obtain the user preferences before obtaining the shopping list from the user.

In further embodiment, the processor may identify the one or more stores based on the user preferences.

In further embodiment, the processor may compute, via the price optimization module, a total cost associated with the shopping list across the plurality of stores when the user preferences indicate that the user prefers to purchase the one or more items from a single store. The processor may compare, via the price optimization module, the total cost associated with the plurality of stores. The processor may select, via the price optimization module, a first store from the plurality of stores based on the comparison. The first store offers a lowest total cost across the plurality of stores. The processor may display, via the display module, the information associated with the first store.

In another embodiment, the processor may determine, via the price optimization module, an optimal combination of two or more stores, from the plurality of stores, that collectively offer a minimum cost of the shopping list when the user preferences indicate that the user prefers to purchase the one or more items at an overall lowest total cost and is willing to shop from more than one shop. The processor may display, via the display module, the information associated with the combination of two or more stores.

In further embodiment, the processor may aggregate, via a unified cart and payment integration module, the normalized item information associated with the one or more items from the one or more stores into a unified cart. The processor may process, via the unified cart and payment integration module, a payment in one transaction to purchase the one or more items from the one or more stores responsive to aggregating the normalized item information into the unified cart.

In further embodiment, the processor may distribute, via an order segmentation module, the unified cart into individual orders to the one or more stores. In further embodiment, the processor may provide, via an inventory module, real-time updates to the user on at least one of: an inventory, an availability, and a delivery status of the one or more items.

In further embodiment, the processor may identify, via the product matching module, the matching items equivalent to the one or more items across the plurality of stores based on the normalized item information. The processor may compute, via the product matching module, a matching score associated with the matching items. The processor may further determine, via the product matching module, whether the matching score is less than a threshold value.

In further embodiment, the processor may obtain, via the product matching module, a user confirmation on the matching items from the user responsive to a determination that the matching score is less than the threshold value. The processor may compare, via the product matching module, prices of the matching items from the one or more items across the plurality of stores responsive to a determination that the matching score is greater than the threshold value.

In further embodiment, the system further comprises a user interface configured to obtain the shopping list from the user and display the information associated with the one or more stores. The information associated with the one or more stores may include at least one of a price information associated with the one or more items, a total checkout price, and a name or identifier associated with the one or more stores.

In accordance with embodiments of the invention, there is also provided a method for optimizing multi-store shopping experience as detailed herein.

In a preferred embodiment, the method includes a step of providing a system that comprises the memory and the processor.

In one embodiment, the method includes a step of obtaining, via the processor, a shopping list from a user. The shopping list may include one or more items. The method may further include a step of collecting, via the processor, an item information associated with the one or more items from a plurality of stores. The item information may include a price information for the one or more items offered by the plurality of stores. The method may further include a step of normalizing, via the processor, the item information to standardized units, formats, and names across the plurality of stores to form a normalized item information. The method may further include a step of comparing, via the processor, prices of similar/matching items from the one or more items across the plurality of stores based on the normalized item information. The method may further include a step of determining, via the processor, a lowest price of each item from the one or more items across the plurality of stores based on the comparison. The method may further include a step of identifying, via the processor, one or more stores from the plurality of stores to purchase the one or more items responsive to determining the lowest price of each item across the plurality of stores. The method may further include a step of displaying, via the processor, an information associated with the one or more stores.

In further embodiment, the method may further include a step of obtaining user preferences from the user. The user preferences may include at least one of store preferences, dictary restrictions, or a budget information. In some embodiment, the step of identifying the one or more stores may include identifying the one or more stores based on the user preferences.

In accordance with embodiments of the invention, there is also provided a non-transitory computer-readable storage medium having instructions stored thereupon which, when executed by a processor, cause the processor to perform steps as detailed herein.

In a preferred embodiment, the processor may obtain a shopping list from a user. The shopping list may include one or more items. The processor may collect an item information associated with the one or more items from a plurality of stores. The item information may include a price information for the one or more items offered by the plurality of stores. The processor may normalize the item information to standardized units, formats, and names across the plurality of stores to form a normalized item information. The processor may compare prices of matching items across the plurality of stores based on the normalized item information, and determine a lowest price of each item from the one or more items across the plurality of stores based on the comparison. The processor may identify one or more stores from the plurality of stores to purchase the one or more items responsive to determining the lowest price of each item across the plurality of stores, and display an information associated with the one or more stores.

The present disclosure describes a system and method optimizing shopping experience for users. The system compares prices of consumer products sold in a geographical area, highlights the cheapest options, and allows the users to purchase items from multiple stores. The system compares prices of the same or similar items across local stores, and provides a central shopping platform for users to shop from multiple stores. The system further allows the users to upload data for redeemable points/incentives and view advertisements for discounts. The system is scalable and capable of comparing prices for any type of product from any store. The system provides or renders a user interface that includes features like barcode scanning, autocomplete search, and navigation by departments. The system offers various shopping options like single-store, two-store, and multi-store with GPS integration for efficient routing. The system further provides a checkout page, confirmation page, and order tracking capabilities.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 illustrates an exemplary process for multi-store price optimization and seamless checkout, in accordance with embodiments of the invention;

FIG. 2 is an exemplary platform for multi-store price optimization and seamless checkout, in accordance with embodiments of the invention;

FIG. 3 illustrates a first snapshot of a user interface of the platform of FIG. 2, in accordance with embodiments of the invention;

FIG. 4 illustrates a second snapshot of the user interface of the platform of FIG. 2, in accordance with embodiments of the invention;

FIG. 5 illustrates a third snapshot of the user interface of the platform of FIG. 2, in accordance with embodiments of the invention;

FIG. 6 illustrates a fourth snapshot of the user interface of the platform of FIG. 2, in accordance with embodiments of the invention; and

FIG. 7 illustrates the steps performed in a method for optimizing multi-store shopping experience in accordance with embodiments of the invention.

### DETAILED DESCRIPTION

For a further understanding of the nature and function of the embodiments, reference should be made to the following detailed description. Detailed descriptions of the embodiments are provided herein, as well as the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

The present disclosure broadly discloses a system and method for optimizing multi-store shopping experience of a user. The system compares the prices and other information of consumer products sold in a geographical area across a plurality of stores. The system displays the prices of the same or similar items sold at local stores to the user and may emphasize to the user the cheapest option. The system may be used to simply compare prices amongst several stores or to purchase one or more item from one or more available stores. The system is compatible with online webstores and applications of local merchants and stores to allow the user to buy their goods through the described system and send the user's order to the merchant or store for fulfillment.

More specifically, the system and method leverages one or more algorithms that collect and normalize price data for multiple products in a user's shopping list, match similar products across stores, calculate the lowest prices, and generate optimized shopping lists. The system also integrates a unified cart and single payment gateway to ensure a seamless checkout process. Furthermore, the system incorporates user preferences to deliver a personalized shopping experience.

Reference will now be made in detail to the present preferred embodiments of the invention, examples of which are illustrated in the accompanying drawings. Wherever possible, the same reference numerals are used in the drawings and the description to refer to the same or like parts.

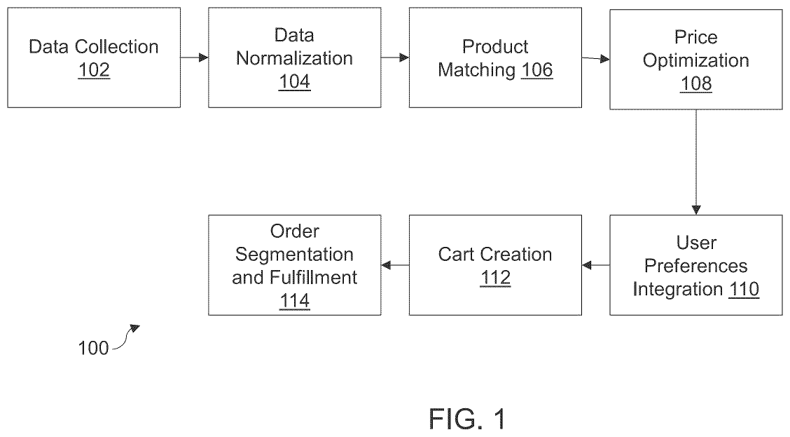

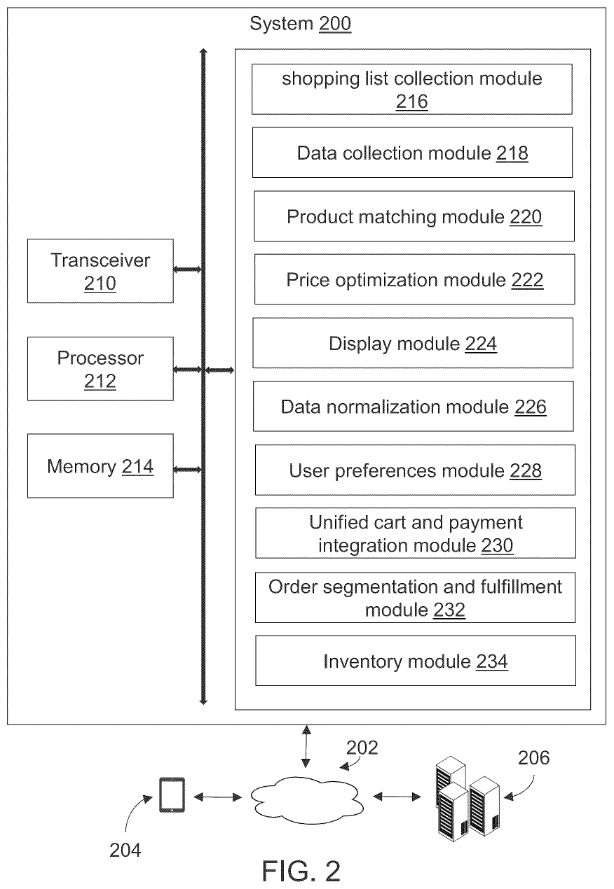

As illustrated in FIG. 1, in a preferred embodiment, an exemplary process 100 for multi-store price optimization and seamless checkout is disclosed, in accordance with embodiments of the invention. The process 100 is executed by a system or platform (depicted as system 200 in FIG. 2 and described later in the description below) to provide enhanced multi-store shopping experience to a user, without requiring the user to visit multiple stores to purchases items in the user's shopping list. The process 100 enables the user to search and compare prices of the same or similar products across stores and merchants in a user's geographical location, and purchase the products via a single checkout/transaction. The process 100 gives the user the ability to shop and compare prices of competitors from a convenient, centralized source. The process 100 enables the user to shop from delis, bakeries, and butchers of multiple grocers from the convenience of the user's home and find the best prices on the products in the user's area before purchasing.

The system 200 enables the process 100 to include a plurality of steps including, but not limited to, a data collection step 102, a data normalization step 104, a product matching step 106, a price optimization step 108, a user preference integration step 110, a cart creation step 112 and an order segmentation and fulfillment step 114. The order of the steps 102-114 depicted in FIG. 1 and described below should not be construed as limiting, and the ordering of the steps 102-114 may be modified without departing from the scope of the present disclosure. For example, the user preference integration step 110 may be performed before the price optimization step 108, without departing from the scope of the present disclosure.

At the data collection step 102, the system may obtain a shopping list from the user, which may include one or more items that the user may be interested in purchasing from one or more stores via the system. In some embodiments, to obtain the shopping list or assist the user in “building” the shopping list on the system, the system may enable the user to browse products by department, category, price, ratings, keyword searches, etc. on the system. The system may redirect the user through affiliate links to access a store's own website or application and direct the user to the online listings or webpages of the products/items that the user is interested in purchasing.

In some embodiments, the system 200 may render a main search page on a user device (shown as a user device 204 in FIG. 2, through which the user may be accessing the system 200), and the search page may include a link to an in-app barcode scan function or a 3rd party application through which the user may scan an item's barcode in real time to locate the item on the system 200 and build the shopping list (e.g., for price comparison across other local stores, purchase through the application, etc., as described later below). In additional embodiments, the search page may contain a navigation bar that enable the user to search for products and/or stores on the system 200 and build the shopping list.

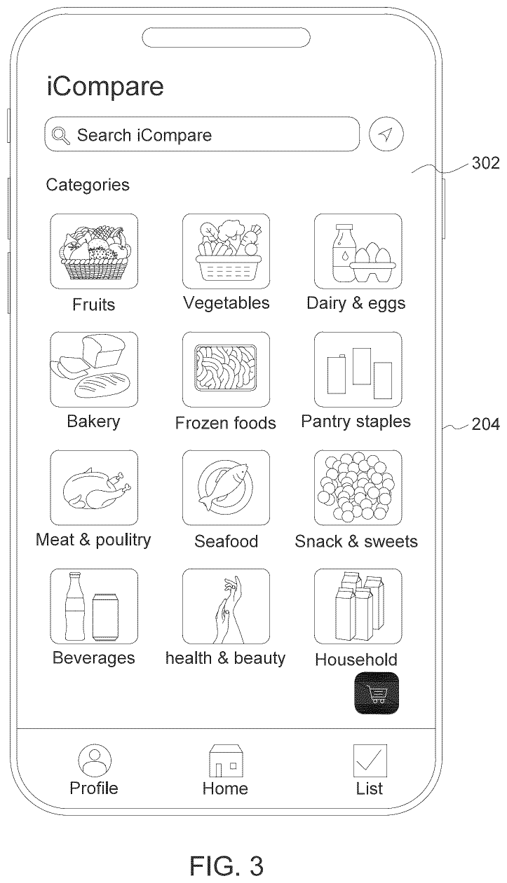

In one exemplary embodiment, the navigation bar that is displayed on the user interface 302 of the user's device 204 includes autocomplete and suggestions features which can make suggestions to the user based on the user's current input and/or past searches. In a preferred embodiment, positioned below the search bar 402 on the user display interface 302, there are options for the user to shop by department (e.g., Bakery, Frozen foods, Pantry staples), as illustrated in FIG. 3, wherein the departments are preferably listed in order of either popularity, alphabetically, categorically, etc. The selection of a department by the user directs the user to a department-specific page that contains categories and subcategories of products in that department. Referring to FIG. 3, some examples of departments are the deli, bakery, poultry, beef, seafood, vegetables, alcohol, frozen items, cookware, etc. Each product or item displayed on the search page may have relevant information listed with it, such as an image, name, price, affiliate link, item number, isle or bay location in-store, etc. The items may have an associated “Add to Cart” button or similar button that functions to place one or more items in the user's shopping session cart or the user's shopping list. The system 200 also suggests to the user items that are similar to, substitute for, or related to the items in the user's cart or shopping list. The user can also select an affiliate link button to go to an item's page on an affiliate company's website or application.

In some embodiments, the navigation bar described above may be a set of destination links, which serves to help the user to find his/her way through the system 200 and its many listed stores and products/items. In an exemplary embodiment, the navigation bar may include categories of products/items such as “Electronics”, “Groceries”, “Clothing”, and more. Selecting a category allows the user to navigate to a new page that displays all the products/items under the selected category and the different stores that sell those products or categories of products. The navigation bar may further incorporate category icons that have distinctive icons for visual appeal and recognition by the user. The navigation bar may incorporate drop-down lists from the main categories to display subcategories. For example, Electronics may further be divided into “Mobile Phones”, “Laptops”, “TVs”, etc. The navigation bar is further operable to be customized based on a user's preferences and shopping history. The user may also have the option to add or remove categories based on the user's preferences.

It may be appreciated from the description above that the features described above that are offered/provided by the system 200 enables the user to conveniently build the shopping list on the system 200, at the data collection step 102.

At the data collection step 102, the system 200 may also gather item data/information (including pricing data, volume of content per item, item name, etc.) of a plurality of items from multiple stores or a plurality of stores. The system 200 may collect the item data via web scraping and APIs from various stores, ensuring real-time price data is available. In some embodiments, the item data/information described above may include relevant shopping information from grocers' websites or other information sources, such as available inventory, product pricing, clearance pricing, soon to be discontinued status, new products, restock schedules, item names/aliases, etc. The system 200 is operable to accommodate local grocers with limited online presences and/or online competency, and allow them to compete with the bigger chain competitors in the area. In some embodiments, the system 200 is scalable to be able to obtain/gather item information of any type of product/item from any type of store on the internet and/or locally.

Responsive to performing the data collection step 102, the process 100 may move on to the data normalization step 104. At the data normalization step 104, the system 200 may normalize, standardize or convert the collected item data/information into consistent, standard formats and units for accurate comparison (to be perform at the product matching step 106). In some embodiments, at the data normalization step 104, the system 200 may normalize or standardize inconsistent name spellings or aliases, item description, pricing details, volume of content per item (e.g., grams, liters, etc.) to a standard unit. It may be appreciated that as the system 200 gathers the item information from a plurality of stores, there is high likelihood of inconsistent or non-standardized usage of item names, item description, pricing details, content details, etc. associated with the same or similar product across the multiple stores. To ensure that the item information if standardized/consistent and in a “usable” format for the subsequent steps of the process 100, the system 200 performs the data normalization step 104. In some embodiment, the system 200 may perform one or more Artificial Intelligence (AI)/Machine Learning (ML) based algorithms or one or more known item inventory information standardization databases/algorithms to perform the data normalization step 104 described above.

Responsive to performing the data normalization step 104 and obtaining a normalized item information as the output of the step 104, the process 100 moves onto the product matching step 106. At the product matching step 106, the system 200 preferably uses the normalized item information to identify or match similar products (that may be equivalent or similar to the items included in the user's shopping list) across the plurality of stores by using algorithms and manual verification to ensure accurate price comparisons in the subsequent steps of the process 100. As an example, if the user has included items A, B and C in the user's shopping list, then at the product matching step 106, the system 200 identifies products similar or equivalent to the items A, B and C in the plurality of stores by using the normalized item information. The system 200 can further use the normalized item information to identify the item information (e.g., pricing data) for the items A, B and C offered by each store of the plurality of stores at the product matching step 106. For example, the system 200 can identify that the prices of A, B and C are P1, P2 and P3 in a first store, P1, P4, P5 in a second store, P6, P7, P3 in a third store, and/or the like.

In some embodiments, in the case of ambiguous matching of items, the product matching step 106 preferably includes an additional step of manual or human verification, through which the system 200 can confirm the accuracy of the matched items. For example, if the system 200 has a low confidence that the “matched” item in the first store is indeed the item A, the system 200 can output a prompt on the user device requesting the user to confirm the identified matched item. Responsive to the user confirming the matching of the identified matched item, the system 200 can determine that the matched item in the first store is the item A.

At the price optimization step 108, the system 200 calculates the lowest prices of the items A, B and C across the plurality of stores based on the prices identified above, and generates an “optimized” shopping list associated with the items A, B and C. In some embodiments, at the price optimization step 108, the system 200 may consider total cost calculation of purchasing the items A, B and C, if purchasing the items from multiple stores versus a single store. The system 200 also calculates total savings from using the optimized shopping list at the price optimization step 108.

In some embodiments, at the price optimization step 108, the system 200 identifies the lowest price for each item, of the items A, B and C, across all the stores. For example, the system 200 can identify that the price of item A is lowest in the first store, the price of item B is lowest in the second store, and the price of item C is lowest in the third store. The system 200 can further compute the total cost of purchasing all the three items, if the user purchases from multiple stores vs. a single store. For example, the system 200 can identify that the total cost will be the lowest if the user purchases the item A from the first store, the item B from the second store, and the item C from the third store. The system 200 can additionally identify a first total cost if the user purchases all the items A, B and C from the first store, a second total cost if the user purchases all the items A, B and C from the second store, and a third total cost if the user purchases all the items A, B and C from the third store.

Responsive to executing the price optimization step 108, the system 200 can execute the user preference integration step 110. At the user preference integration step 110, the system 200 preferably incorporates user preferences into the optimization process. The user preferences may be, for example, preferences associated with whether the user desires to purchase the items A, B and C from a single store or willing to purchase for two or more stores, preferences associated with selection or exclusion of certain stores (e.g., based on distance from user's home, within 5 miles of user's home, exclusion of stores the user does not like to visit, etc.), preferences associated with dietary restrictions (e.g., filter products/items based on dietary needs), preferences associated with budget constraints (e.g., consider user-set budgets for shopping trips), and/or the like.

In some embodiments, the user can add/input the user preferences to the system 200 any time before or after adding the items A, B and C to the user's shopping list. For example, the system 200 may render a grocery list page (which may be the same as or different from the search page described above) wherein the user may enter the user's grocery/shopping list and/or the desired products/items. After the grocery list is entered, the system 200 provides one or more shopping options to the user. One shopping option provided by the system 200 may be for all the groceries on the user's shopping list to be purchased at the same store for the lowest total price. This single-store shopping option enables the system 200 to provide/display (as described later below) the user with the lowest price for which a user can purchase all their groceries at a single location and compare the total price on a store-by-store basis.

In another embodiment, another option provided by the system 200 is a two-store option, in which the user is shown the best total price of buying groceries at their cheapest or most economical price point across two stores, for example. The two-store option displays the lowest total price offering and compares that total price to the one-store option price as well as the total price of various two-store combinations. An example of the two-store option is: if Store A1 has eggs and bread cheaper than Store B1, but Store B1 sells laundry detergent cheaper than Store A1, the system 200 shows the user the total price if the eggs and bread are purchased at Store A and the laundry detergent is purchased at Store B.

In yet another embodiment, another option provided by the system 200 is a multi-store option, in which the user is shown the lowest total cost option, if every grocery item is purchased at its cheapest possible price point across all the listed stores in an area. This option may involve purchasing items from three or more different stores. The multi-store option total price is compared to the total prices of the single-store and two-store options. The multi-store option may allow the user to set a maximum number of stores that the user is willing to travel to, for example, three stores, four stores, or more. The system 200 is capable of employing GPS or a similar location service functionality to offer the user the most efficient, convenient and/or shortest route between multiple stores.

In a similar manner as described above, the system 200 may provide options to the user to provide preferences associated with specific stores, dietary restrictions, budget constraints, and/or the like.

At the user preference integration step 110, the system 200 may incorporate the user preferences into the optimization process such that the optimized shopping list/cart prepared for the user by the system 200 is in sync or aligned with the user preferences. In some embodiments, the system 200 may further allow/enable user adjustments to the preferences, and then dynamically update the optimized shopping list/cart based on the adjustments.

At the cart creation step 112, the system 200 may aggregate the items A, B and C from multiple stores or a single store (based on the user preferences) into a single cart and processes payment. Specifically, at the cart creation step 112, the system 200 may create a unified shopping cart by combining items A, B and C from multiple stores (or a single store, if the user desires so) into a single cart. The system 200 may further provide a payment gateway through which the payment for the item purchase can be processed as a single transaction covering all the stores. Stated another way, the user is required to make the payment just once in a single transaction for purchasing the A, B and C from multiple stores. In this manner, the user is not required to make multiple transactions, even if the items A, B and C are purchased from multiple stores. This considerably streamlines the checkout/payment process for the user, and enhances user's shopping experience.

In some embodiments, at the cart creation step 112, the system 200 may render a “Cart” page on the user device where the user can see the selected items A, B and C, make changes in quantity of items, or remove items. This page also displays the total cost of the items. The system 200 further displays a “Checkout” page where the user can review the order, choose a payment method, apply promotional codes, discounts, coupons, gift cards, etc. (if available/applicable), and finalize the purchase. The “Checkout” page may also contain options for the user to schedule in-store pick-up and/or at-home delivery directly from the store itself, other 3rd party vendors, and/or affiliates. After the “Checkout” page (i.e., after the user may made the payment), the user may be directed to a “Confirmation” page where the user may see a confirmation message with the order details. The user may also track the order from the “Confirmation” page or the “Confirmation” page may provide a link that routes the user to a webpage or application that tracks the order,

At the order segmentation and fulfillment step 114, the system 200 manages order segmentation and fulfillment logistics. Specifically, at the order segmentation and fulfillment step 114, the system 200 may distribute the unified cart into individual orders for each store. The system 200 may additionally support in-store pickup and home delivery, at this step.

The process 100 may include additional steps as well that are not shown in FIG. 1, e.g., obtaining user feedback on the shopping experience, enabling the user to track delivery of orders, enabling the user to return damaged items, displaying promotional offers to the user and enabling the user to redeem promotional offers, and/or the like. Such steps are contemplated in the process 100, and are to be construed as being part of the present disclosure.

FIG. 2 is an exemplary platform or system 200 for multi-store price optimization and seamless checkout, in accordance with embodiments of the invention. FIG. 2 will be described in conjunction with FIGS. 3-6.

The system 200 may be the same system 200 as described above in conjunction with FIG. 1. The system 200 may be hosted on a server, and may be associated with a shopping list application implemented as a website and/or a mobile application. The system 200 may be communicatively coupled with a plurality of systems/devices via one or more network(s) 202. For example, the system 200 may be communicatively coupled with a user device 204 and an external server 206 via the network 202.

The user device 204 may be associated with the user described above, and may be, for example, a desktop computer, tablet, smartphone, a laptop, etc. The server 206 may be associated with the plurality of stores described above, and may be configured to provide the real-time item information (i.e., real-time item information for a plurality of items sold at the plurality of stores) to the system 200 at a predefined frequency (e.g., updated every 5, 10, 15, 60, 120 seconds, etc.). The examples of the item information are already described above in conjunction with FIG. 1.

The network 202 illustrates an example communication infrastructure in which the connected devices discussed in various embodiments of this disclosure may communicate. The network 202 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The system 200 may include a plurality of units/modules communicatively coupled with each other via a bus 208. The units/modules include, but are not limited to, a transceiver 210, a processor 212, a memory 214, a shopping list collection module 216, a data collection module 218, a product matching module 220, a price optimization module 222, a display module 224, a data normalization module 226, a user preferences module 228, a unified cart and payment integration module 230, an order segmentation and fulfillment module 232, an inventory module 234, and/or the like.

The modules described above may be stored in the form of computer-executable instructions, and the processor 212 is configured and/or programmed to execute the stored computer-executable instructions for performing functions/operations in accordance with the present disclosure. The functions of the modules are further described in the description below.

In preferred embodiments, all of the modules described above are part of the system 200, as shown in FIG. 2. In other embodiments, one or more modules may be outside of the system 200 (e.g., part of the server 206), and communicatively coupled with the system 200. In further embodiments, one or more modules are part of the memory 214. Furthermore, in some embodiments, one or more modules depicted in FIG. 2 are preferably integrated into a single module rather than separate modules.

The transceiver 210 is configured to receive or transmit information/data/signal from or to external devices (e.g., the user device 204, the server 206, etc.) and the system components (e.g., the modules described above). The processor 212 utilizes the memory 214 to store programs in code and/or to store data for performing aspects in accordance with embodiments of this disclosure. The memory 214 may be a non-transitory computer-readable storage medium or memory storing a program code that enables the processor 212 to perform operations in accordance with the present disclosure. The memory 214 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically crasable programmable read-only memory (EEPROM), programmable read-only memory (PROM), etc.)

In a preferred embodiment, the shopping list collection module 216 enables the processor 212 to obtain the user's shopping list containing one or more items (e.g., items A, B and C described above) from the user via the user device 204 and the transceiver 210. The data collection module 218 enables the processor 212 to obtain/gather the item information described above (including price data) associated with a plurality of items from a plurality of stores. In one embodiment, the data collection module 218 collects data via web scraping of various websites of stores, ensuring real-time price data is available to the processor 212. As used herein, web scraping, or data scraping, is a process of importing data from websites into files or spreadsheets. Web scraping is used to extract data from the web, for use by the system, to reuse the data and, using the display module 224, to display the data in a different form, where the system display the reused data on the display interface 302.

In another embodiment, the data collection module 218 collects data via one or more Application Programming Interfaces (APIs) from various stores, ensuring real-time price data is available to the processor 212. As used herein, collecting data from an API means using an API to access data from another source and then use that data for analysis. APIs are software communication protocols that allow applications to exchange data and perform tasks.

The data collection module 218 preferably executes custom scripts to fetch data from store websites, and the data collection module 218 preferably has direct integration with store APIs for real-time price data.

The product matching module 220 enables the processor 212 to match similar products/items (that may be equivalent to the items A, B and C) across different stores or the plurality of stores to enable accurate price comparison, as described above in conjunction with FIG. 1. This module also enables manual verification in the case of ambiguous matching, to ensure accurate price comparisons. The product matching module 220 uses algorithms to identify products/items equivalent to the items A, B and C in the user's shopping list, and adds a layer of human verification for ambiguous matches. As can be appreciated from the disclosure herein, the system allows users to search and compare prices of the same or similar products of all the grocery stores in a respective user's geographical location, and each user, using the system, can browse by department or undertake keyword searches.

In one embodiment, the system provides the user with redirect affiliate links to access each grocery store's respective site of the respective product of interest.

The price optimization module 222 of the system enables the processor 212 to calculate the lowest prices and generate an optimized shopping list for the user. Specifically, the price optimization module 222 performs a price calculation by finding the lowest price for each item across all of the stores, performs a total cost calculation by computing the total cost of items if purchasing from multiple stores versus a single store, and performs a savings calculation by calculating total savings from using the optimized shopping list that is generated by the system.

The display module 224 enables the processor 212 to display information associated with one or more recommended stores from where the user may purchase the items A, B and C on the user device 204. The information associated with the recommended stores may include a price information associated with the items A, B and C from each recommended store, a total checkout price, a name or identifier associated with the recommended stores, and/or the like. As can be appreciated from the disclosure herein, the system provides user shoppers (i.e., user or users, herein) the ability to save money whilst shopping, all from one location, such that users can compare the prices of competitors on users' desired products, all at the users' fingertips. Users can, using the system, shop at grocery's, deli's, bakeries, and butchers, for example, from the convenience of the user's current location, such as while at the user's home or office, and embodiments of the disclosed invention enable users to find the best and most economical prices on desired products in the users' respective area prior to purchasing the desired products.

The data normalization module 226 may enable the processor 212 to convert the collected data or item information into consistent formats and units for accurate comparison, as described above in conjunction with FIG. 1. In some embodiments, the data normalization module 226 may perform unit conversion by converting item prices and other item information to a standard unit (e.g., grams, liters), and also standardize formats to ensures consistent naming and descriptions for products/items in the item information.

The user preferences module 228 enables the processor 212 to incorporate user preferences into the optimization process (e.g., for generating the optimized shopping list described above). The user preferences module 228 allows users to select or exclude certain stores, filters products/items based on dietary needs/restrictions, provide user-set budgets for shopping trips, and/or the like.

The unified cart and payment integration module 230 enables the processor 212 to aggregate items from multiple stores into a single cart and process payment. Specifically, the unified cart and payment integration module 230 combines products/items from various stores into a single unified cart, and provide a payment gateway that processes a single transaction covering all stores.

The order segmentation and fulfillment module 232 enables the processor 212 to manage order segmentation and fulfillment logistics. Specifically, the order segmentation and fulfillment module 232 distributes the unified cart into individual orders for each store (“order segmentation”), and supports in-store pickup and home delivery (“fulfillment options”).

The inventory module 234 enables the processor 212 to provide real-time updates to the user on inventory, availability, delivery status of one or more items, and/or the like.

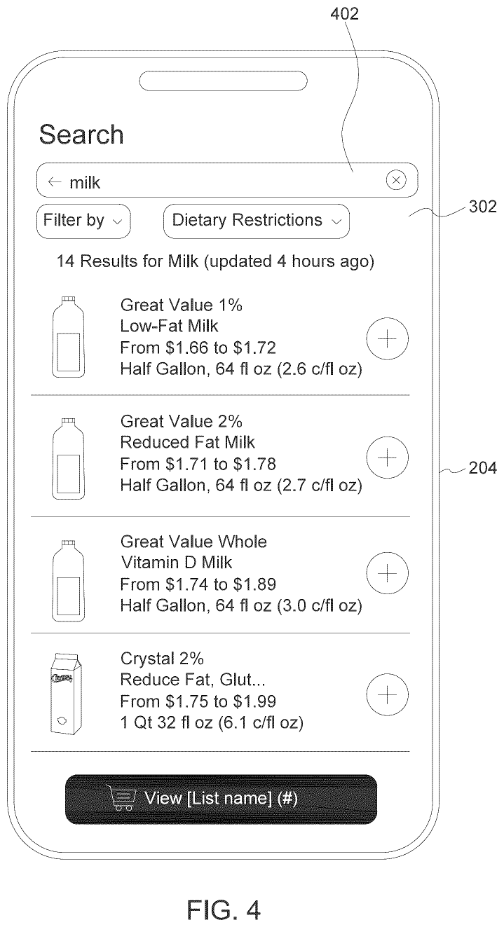

In operation, the processor 212 may obtain, via the shopping list collection module 216, a shopping list from the user. The shopping list may include one or more items that the user may be interested in purchasing, e.g., the items A, B and C described above. As described above in conjunction with FIG. 1, the user may add items or “build” the shopping list on the system 200 by browsing items via product categories, as shown on a user interface 302 of the user device 204 in FIG. 3. For example, as shown in FIG. 3, the user may add items to the shopping list by browsing and selecting items from categories such as “Fruits”, “Vegetables”, “Dairy and Eggs”, “Bakery”, “Frozen foods”, etc. In other embodiments, as shown in FIG. 4, the user may add items to the shopping list by searching the items (e.g., “Milk”) on a search bar 402 rendered on the user interface 302.

The processor 212 may further collect, via the data collection module 218 (and the server 206), the item information associated with a plurality of items (including the items A, B and C) from a plurality of stores. The examples of the item information are already described in conjunction with FIG. 1. In an exemplary embodiment, the item information may include pricing information for the items A, B and C offered for sale by the plurality of stores.

The processor 212 may further normalize, via the data normalization module 226, the obtained item information to standardized units, formats and names across the plurality of stores, as described above. The processor 212 may then identify, via the product matching module 220, similar or matching items equivalent to the items A, B, C across the plurality of stores based on the normalized item information. In some embodiments, the processor 212 may compute, via the product matching module 220, a matching score associated with each matching or “matched” item, and determine whether the matching score is less than a threshold value. The processor 212 may obtain, via the product matching module 220 and the user device 204, a user confirmation on the matching or matched item from the user responsive to a determination that the matching score is less than the threshold value.

The processor 212 may further compare, via the product matching module 220, prices of the similar or matching/matched items (for the items A, B, C, for example) across the plurality of stores responsive to a determination that the matching score is greater than the threshold value. The processor 212 may perform the comparison step described above based on the pricing information of items included in the normalized item information.

The processor 212 determines, via the price optimization module 222, a lowest price of each item A, B, C across the plurality of stores based upon the comparison. In a preferred embodiment, the processor 212 further identifies, via the price optimization module 222, one or more “recommended” stores from the plurality of stores to purchase the items A, B, C responsive to determining the lowest price of each item across the plurality of stores. In some embodiments, the processor 212 may identify the recommended stores based on user preferences.

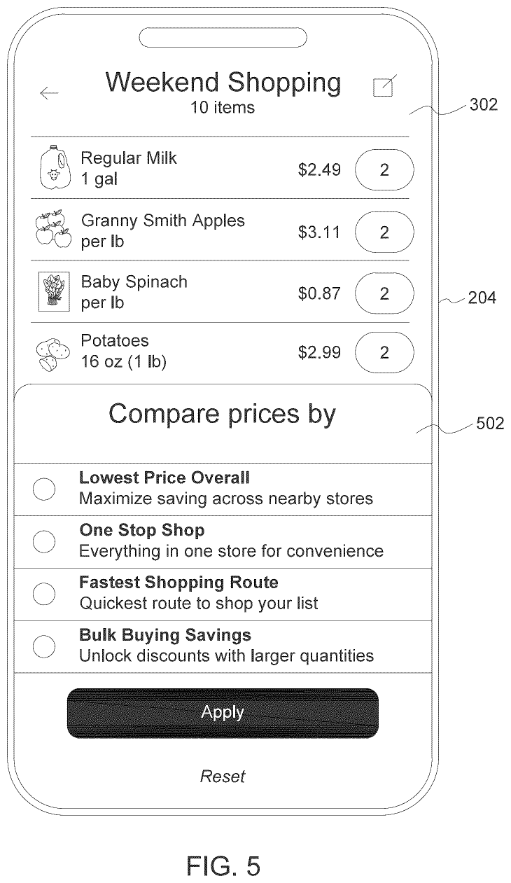

In some embodiments, before obtaining the shopping list from the user or responsive to obtaining the shopping list from the user, the processor 212 obtains, via the user preferences module 228 and the user device 204, the user preferences from the user. In a preferred embodiment, as described above, the user preferences include store preferences, dietary restrictions, a budget information/constraint, and/or the like. An example view of the user interface 302 showing different options of user preferences 502 is depicted in FIG. 5. As shown in FIG. 5, the user may provide user preference for lowest price overall, one shop stop, fastest shopping route, bulk buying savings, and/or the like.

As described above, the system, using the processor 212, identifies the recommended stores based on user preferences. For example, when the user preferences indicate that the user prefers to purchase the items A, B, C at the lowest prices from a single store, the processor 212 may identify a single store from where the user may purchase all those items at the lowest possible price. In this case, the processor 212 computes, via the price optimization module 222, a total cost associated with the shopping list/items A, B, C across the plurality of stores. The processor 212 further compares, via the price optimization module 222, the total cost of purchasing the items A, B, C associated with the plurality of stores and then selects one store (a “first store”) from the plurality of stores based upon the comparison. The first store offers the lowest total cost for the items A, B, C from across the plurality of stores, and thus, the system identifies and recommends to the user the “first store” as the single store from where the user may purchase all those items at the lowest possible price.

As another example, when the user preferences indicate that the user prefers to purchase the items A, B, C at an overall lowest total cost and is willing to shop from more than one shop, the processor 212 may identify two or more stores (or “second stores”) from where the user may purchase all the items at the lowest possible overall total cost/price. In this case, the processor 212 may determine, via the price optimization module 222, an optimal combination of two or more stores, from the plurality of stores, that collectively offer a minimum total cost of the shopping list/items A, B, C.

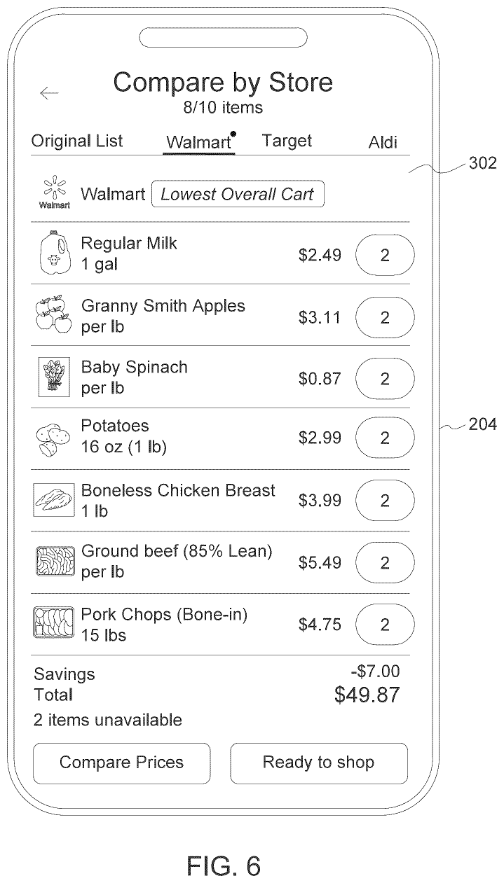

Responsive to determining the recommended store(s) as described above, the processor 212 may display, via the display module 224, an information associated with the recommended stores (e.g., the first store or the second stores described above) on the user interface 302, as shown in FIG. 6. In some embodiments, the user interface 302 may be associated with a system application that may be getting executed on the user device 204. In this case, the user interface 302 may be configured to obtain the shopping list, user preferences, etc. from the user, and display the information associated with the recommended stores. As shown in FIG. 6, the information associated with the recommended stores may include price information associated with the items A, B, C (or the items that the user desires to purchase), a total checkout price, a name or identifier of the recommended store(s), and/or the like.

In some embodiments, before displaying the information associated with the recommended stores, the processor 212 may aggregate, via the unified cart and payment integration module 230, the normalized item information associated with the items A, B, C from the recommended stores into a single unified cart (or an “optimized shopping list”) to facilitate the user in conveniently making the payment via a single transaction, as described above. Responsive to the user making the payment, the processor 212 may process, via the unified cart and payment integration module 230, the payment in one transaction to enable the user to purchase the items A, B, C from the recommended stores in one go.

The processor 212 may further distribute, via the order segmentation and fulfillment module 232, the unified cart into individual orders to the recommended stores. The processor 212 may further provide, via the inventory module 234, real-time updates to the user on the inventory, the availability, the delivery status of the items A, B, C, and/or the like.

As a brief example of the operation of the system 200, a user may input a shopping list with preferences for organic products and a budget constraint on the system 200. The system 200 may collect and normalize data from multiple stores, match similar products, calculate the lowest prices, and generate an optimized shopping list. The user may then review the list, make adjustments, and complete the purchase through a unified cart and single payment gateway. As another example, the user may exclude certain stores and set dietary restrictions for gluten-free products. In this case, the system 200 may adjusts the optimization process based on these preferences, ensuring that the final shopping list adheres to the user's requirements.

In addition to the features described above, the system 200 may offer additional features to the user. For example, the system 200 may allow the user to upload photos, reviews, prices and other data about products purchased from stores in exchange for redeemable points. The user can exchange the redeemable points through the shopping application and/or website for discounts, coupons, gift cards, perks and/or other items. The user may also be able to opt to receive additional advertising in exchange for benefits, discounts, coupons, gift cards, perks and/or other items or a chance to receive additional benefits, discounts, coupons, gift cards, perks and/or other items. The discounts or other perks of particular stores may be made available to the user for viewing an advertisement.

The system 200 may additionally render a welcome screen on the user device 204 that contains a logo and the name of the system application in a simple and intuitive interface. After a period of time, the welcome screen is replaced with a login/signup screen where users can input their login information to access their accounts. The login/signup screen provides the common “Forgot Password” and “Remember Me” functions as well. If a user is new to the application, there will be a sign-up option in which the users may register with their email or users may link a shopping application account to another account such as Google™ or Facebook™. After a login, a user is either directed to their existing profile or to a profile building page. The profile building page allows the users to input personal details like their name, contact number, delivery address, payment information and more. The users may also be able to upload a profile picture. This information may facilitate purchases and delivery services through the application. The information may also be provided to 3^{rd} party websites and/or applications to facilitate sales, deliveries or other related services.

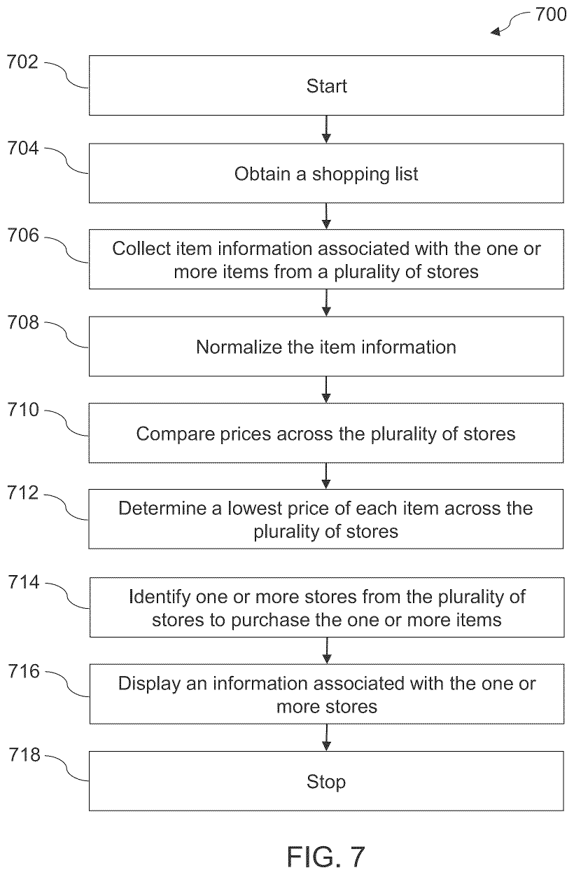

FIG. 7 illustrates the steps performed in a method 700 for optimizing multi-store shopping experience in accordance with embodiments of the invention. FIG. 7 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 700 starts at step 702. At step 704, the method 700 includes obtaining, by the processor 212, the shopping list from a user, which includes one or more items. At step 706, the method 700 includes collecting, via the processor 212, an item information associated with the one or more items from a plurality of stores. The item information includes a price information for the one or more items offered by the plurality of stores.

At step 708, the method 700 includes normalizing, via the processor 212, the item information to standardized units, formats, and names across the plurality of stores. At step 710, the method 700 includes comparing, via the processor 212, prices of matching items across the plurality of stores based on the normalized item information. At step 712, the method 700 includes determining, via the processor 212, a lowest price of each item from the one or more items across the plurality of stores based on the comparison.

At step 714, the method 700 includes identifying, via the processor 212, one or more stores from the plurality of stores to purchase the one or more items responsive to determining the lowest price of each item across the plurality of stores. At step 716, the method 700 includes displaying, via the processor 212, an information associated with the one or more stores. At step 718, the method 700 ends.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A system for optimizing multi-store shopping, the system comprising:
a user device having a display interface;
a processor; and
a memory storing instructions that, when executed by the processor, causes the processor to:
obtain, via a shopping list collection module, a shopping list from a user, wherein the shopping list comprises one or more items;
collect, via a data collection module, an item information associated with the one or more items from a plurality of stores, wherein the item information comprises a price information for the one or more items offered by the plurality of stores;
normalize, via a data normalization module, the item information to standardized units, formats, and names across the plurality of stores to form a normalized item information;
compare, via a product matching module, prices of matching items across the plurality of stores based on the normalized item information;
determine, via a price optimization module, a lowest price of each item from the one or more items across the plurality of stores based on the comparison;
identify, via the price optimization module, one or more stores from the plurality of stores to purchase the one or more items responsive to determining the lowest price of each item across the plurality of stores; and
display on the display interface, via a display module, an information associated with the one or more stores.

2. The system of claim 1, wherein the memory further stores instructions that, when executed by the processor, causes the processor to:
obtain, via a user preferences module, user preferences from the user, wherein the user preferences comprise at least one of store preferences, dietary restrictions, or a budget information.

3. The system of claim 2, wherein the processor is configured to obtain the user preferences responsive to obtaining the shopping list from the user.

4. The system of claim 3, wherein the processor is configured to obtain the user preferences before obtaining the shopping list from the user.

5. The system of claim 3, wherein the processor is configured to identify the one or more stores based on the user preferences.

6. The system of claim 5, wherein the memory further stores instructions that, when executed by the processor, causes the processor to:
compute, via the price optimization module, a total cost associated with the shopping list across the plurality of stores when the user preferences indicate that the user prefers to purchase the one or more items from a single store;
compare, via the price optimization module, the total cost associated with the plurality of stores;
select, via the price optimization module, a first store from the plurality of stores based on the comparison, wherein the first store offers a lowest total cost across the plurality of stores; and
display, via the display module, the information associated with the first store.

7. The system of claim 5, wherein the memory further stores instructions that, when executed by the processor, causes the processor to:
determine, via the price optimization module, an optimal combination of two or more stores, from the plurality of stores, that collectively offer a minimum cost of the shopping list when the user preferences indicate that the user prefers to purchase the one or more items at an overall lowest total cost and is willing to shop from more than one shop; and
display, via the display module, the information associated with the optimal combination of two or more stores.

8. The system of claim 1, wherein the memory further stores instructions that, when executed by the processor, causes the processor to:
aggregate, via a unified cart and payment integration module, the normalized item information associated with the one or more items from the one or more stores into a unified cart; and
process, via the unified cart and payment integration module, a payment in one transaction to purchase the one or more items from the one or more stores responsive to aggregating the normalized item information into the unified cart.

9. The system of claim 8, wherein the memory further stores instructions that, when executed by the processor, causes the processor to distribute, via an order segmentation module, the unified cart into individual orders to the one or more stores.

10. The system of claim 1, wherein the memory further stores instructions that, when executed by the processor, causes the processor to provide, via an inventory module, real-time updates to the user on at least one of: an inventory, an availability, and a delivery status of the one or more items.

11. The system of claim 1, wherein the memory further stores instructions that, when executed by the processor, causes the processor to:
identify, via the product matching module, the matching items equivalent to the one or more items across the plurality of stores based on the normalized item information;
compute, via the product matching module, a matching score associated with the matching items; and
determine, via the product matching module, whether the matching score is less than a threshold value.

12. The system of claim 11, wherein the memory further stores instructions that, when executed by the processor, causes the processor to obtain, via the product matching module, a user confirmation on the matching items from the user responsive to a determination that the matching score is less than the threshold value.

13. The system of claim 11, wherein the memory further stores instructions that, when executed by the processor, causes the processor to compare, via the product matching module, prices of the matching items from the one or more items across the plurality of stores responsive to a determination that the matching score is greater than the threshold value.

14. The system of claim 1 further comprising a user interface configured to obtain the shopping list from the user and display the information associated with the one or more stores.

15. The system of claim 1, wherein the information associated with the one or more stores comprises at least one of a price information associated with the one or more items, a total checkout price, and a name or identifier associated with the one or more stores.

16. A method for optimizing multi-store shopping, the method comprising:
obtaining, via a processor, a shopping list from a user through a display interface of a user device, wherein the shopping list comprises one or more items;
collecting, via the processor, an item information associated with the one or more items from a plurality of stores, wherein the item information comprises a price information for the one or more items offered by the plurality of stores;
normalizing, via the processor, the item information to standardized units, formats, and names across the plurality of stores to form a normalized item information;
comparing, via the processor, prices of matching items across the plurality of stores based on the normalized item information;
determining, via the processor, a lowest price of each item from the one or more items across the plurality of stores based on the comparison;
identifying, via the processor, one or more stores from the plurality of stores to purchase the one or more items responsive to determining the lowest price of each item across the plurality of stores; and
displaying, via the processor, an information associated with the one or more stores.

17. The method of claim 16 further comprising obtaining user preferences from the user, wherein the user preferences comprise at least one of store preferences, dietary restrictions, or a budget information.

18. The method of claim 17, wherein identifying the one or more stores comprises identifying the one or more stores based on the user preferences.

19. The method of claim 16, wherein the information associated with the one or more stores comprises at least one of a price information associated with the one or more items, a total checkout price, and a name or identifier associated with the one or more stores.

20. A non-transitory computer-readable storage medium having instructions stored thereupon which, when executed by a processor, cause the processor to:
obtain a shopping list from a user through a display interface of a user device, wherein the shopping list comprises one or more items;
collect an item information associated with the one or more items from a plurality of stores, wherein the item information comprises a price information for the one or more items offered by the plurality of stores;
normalize the item information to standardized units, formats, and names across the plurality of stores to form a normalized item information;
compare prices of matching items across the plurality of stores based on the normalized item information;
determine a lowest price of each item from the one or more items across the plurality of stores based on the comparison;
identify one or more stores from the plurality of stores to purchase the one or more items responsive to determining the lowest price of each item across the plurality of stores; and
display an information associated with the one or more stores.
